(19) United States
(12) Patent Application Publication
(10) Pub. No.: US 2018/0185796 A1
(43) Pub. Date: Jul. 5, 2018

(54) MIXING NOZZLE UTILIZING TANGENTIAL AIR FLOW

(71) Applicant: Frito-Lay North America, Inc., Plano, TX (US)

(72) Inventors: Sean EICHENLAUB, McKinney, TX (US); Christopher James Koh, Southlake, TX (US); Liang ZHAO, Plano, TX (US)

(21) Appl. No.: 15/395,120

(22) Filed: Dec. 30, 2016

(51) Int. Cl. B01F 5/00; A23P 20/18; A23L 27/00; B01F 3/12; B01F 13/02; B01F 15/02; B05B 7/00; B05B 7/14

(52) U.S. Cl. CPC B01F 5/0057; A23P 20/18; A23L 27/00; B01F 3/1271; B01F 13/0294; B01F 2215/0014; B01F 15/0251; B01F 15/0238; B05B 7/0012; B05B 7/144; A23V 2002/00; B01F 15/0222

(57) ABSTRACT

Embodiments of the present disclosure describe a mixing nozzle, system implementing the mixing nozzle, and corresponding method of use. The mixing nozzle includes a housing defining a mixing chamber that has a sidewall separating a first end from a second end. A set of tangential feed conduits, which are oriented tangentially to the mixing chamber, extend outwardly from the mixing chamber, through the housing. An outlet orifice is located in the second end, which is one end of an exit channel extending through the housing.

### BACKGROUND OF THE INVENTION

### Technical Field

The present invention relates generally to an improved mixing nozzle and corresponding system and method. More particularly the disclosure herein describes a mixing nozzle utilizing tangential air flow for mixing seasoning ingredients within a mixing chamber of the mixing nozzle before spraying. The disclosure also provides for a system utilizing the mixing nozzle and a corresponding method of use.

### Background

Snacks are often seasoned to achieve a desired taste. Seasonings often take the form of dry particulate matter and may include singular ingredients such as salt, pepper, or garlic powder, or may take the form of a proprietary mix of different ingredients. In some instances, seasonings may be applied to snacks in the form of a pre-mixed seasoning slurry formed from particulate matter suspended in a carrier, such as oil. The carrier facilitates the pumping of the seasoning slurry from a slurry holding tank to the nozzle that coats the snack with the seasoning slurry. Some prior art systems require as much as 75 wt % oil to create a slurry that can be easily pumped from the slurry-holding tank to a traditional spray nozzle.

Some consumers have shown a preference for snack products with reduced oil content. Previous attempts at decreasing oil content in the snack product involved reducing the amount of oil used to create the seasoning slurries applied to the snack product. However, those solutions were unsuccessful largely because reduced oil slurries are more difficult to pump and spray.

### SUMMARY OF THE INVENTION

In a first embodiment, the present disclosure provides for an improved mixing nozzle for applying a seasoning mixture onto food pieces to form seasoned food pieces. The mixing nozzle includes a housing defining a mixing chamber that has a sidewall separating a first end from a second end. A set of tangential feed conduits, which are oriented tangentially to the mixing chamber, extend outwardly from the mixing chamber, through the housing. An outlet orifice is located in the second end, which is one end of an exit channel extending through the housing.

In a second embodiment, the present disclosure provides for an improved system for applying a seasoning mixture onto food pieces to form seasoned food pieces. The system includes a mixing nozzle that has a housing defining a mixing chamber with a sidewall separating a first end from a second end. The mixing nozzle also includes a set of tangential feed conduits extending outwardly from the mixing chamber and through the housing. An outlet orifice is located in the second end of the mixing chamber. The system also includes a set of storage vessels connected to the mixing nozzle. The set of storage vessels stores phase-separated seasoning ingredients that are mixed in the mixing nozzle to form the seasoning mixture.

In a third embodiment, the present disclosure provides for a method for applying a seasoning mixture onto food pieces to form seasoned food pieces. A mixing vortex is generated in a mixing chamber of a mixing nozzle. Seasoning ingredients are fed into the mixing nozzle and mixed within the mixing vortex to form a seasoning mixture. The seasoning mixture is then expelled from the mixing nozzle to coat the food pieces.

Other aspects, embodiments, features, and benefits of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a perspective view of a mixing nozzle in accordance with an illustrative embodiment.

FIG. 2 depicts a top view of the mixing nozzle in accordance with an illustrative embodiment.

FIG. 3 is a cross-sectional view of the mixing nozzle of FIG. 2 in accordance with an illustrative embodiment.

FIG. 4a is an illustration of the flow path of compressed air traveling through a mixing nozzle in accordance with an illustrative embodiment.

FIG. 4b is a graph depicting the velocity of moving particles versus a distance of the particles relative to the center of the mixing chamber in accordance with another illustrative embodiment.

FIG. 5 is a cross-sectional view of a mixing nozzle depicting an axial inlet stream in accordance with an illustrative embodiment.

FIG. 6 is a perspective view of an alternate mixing nozzle in accordance with an illustrative embodiment.

FIG. 7 is perspective view of the mixing chamber of the mixing nozzle shown in FIG. 6.

FIG. 8 is a cross-sectional view of the mixing nozzle depicted in FIG. 6 illustrating the mixing of seasoning ingredients in accordance with an illustrative embodiment.

FIG. 9 is a perspective view of a mixing nozzle in accordance with another illustrative embodiment.

FIG. 10 is a perspective view of the mixing chamber of the mixing nozzle depicted in FIG. 9.

FIG. 11 is a cross-sectional view of the mixing nozzle shown in FIG. 9 illustrating the mixing of seasoning ingredients in accordance with another illustrative embodiment.

FIG. 12 is simplified system implementing a mixing nozzle in accordance with an illustrative embodiment.

FIG. 13 is a simplified system implementing a mixing nozzle in accordance with another illustrative embodiment.

FIG. 14 a flowchart of a process for mixing ingredients to form a seasoning in accordance with an illustrative embodiment.

### DETAILED DESCRIPTION

Embodiments provided herein describe an improved mixing nozzle, system, and corresponding method for seasoning food pieces. The system includes a novel mixing nozzle that mixes the seasoning ingredients within an interior mixing chamber immediately before spraying the seasoning mixture onto food pieces. Seasoning ingredients may be maintained in the system as phase-separated ingredients, which means that the solid seasoning ingredients may be stored separately from the liquid seasoning ingredients.

Novel aspects of the improved nozzle, system, and corresponding method recognize certain disadvantages with existing systems that apply seasoning mixtures onto food pieces. For example, as previously mentioned, existing seasoning systems often utilize a pre-mixed seasoning slurry that requires a minimum amount of oil so that the slurry can be easily pumped from a storage vessel and sprayed from traditional nozzles. As a result, prior art systems may produce seasoned food pieces with unnecessarily high levels of oil. Further, seasoning slurries that are maintained in storage vessels prior to application are often mixed in large quantities. Invariably, surplus amounts of seasoning slurry are discarded as waste after all the food pieces have been exhausted. Lastly, currently existing seasoning systems require a significant investment of time and effort to change between different seasoning applications. To change a system to season a different product, a seasoning tank must be emptied and cleaned before new slurry can be mixed.

The improved mixing nozzle and accompanying system can accommodate seasoning mixtures that use significantly less oil than prior art systems. Because the seasoning ingredients are mixed in the mixing nozzle, seasoning mixtures are not constrained by a minimum amount of oil that is required for pumping and spraying using conventional system components. Further, waste is eliminated because the seasoning slurry is mixed in the mixing nozzle immediately before spraying. Once the food pieces have run out, shutting off feed to the nozzle stops the flow of seasoning ingredients, preserving the unused seasoning ingredients in their respective storage vessels which can be used again at a later date for seasoning the same type of food pieces or entirely different food pieces. Lastly, because the seasoning mixture is mixed in the mixing nozzle, the system can be easily changed between different seasoning applications without the need to clean and sanitize large pieces of equipment. In most cases, the improved mixing nozzle can be flushed with steam or some form of cleaning solution before changing seasoning applications. On occasion, the mixing nozzle can be quickly and easily changed out with a sanitized mixing nozzle.

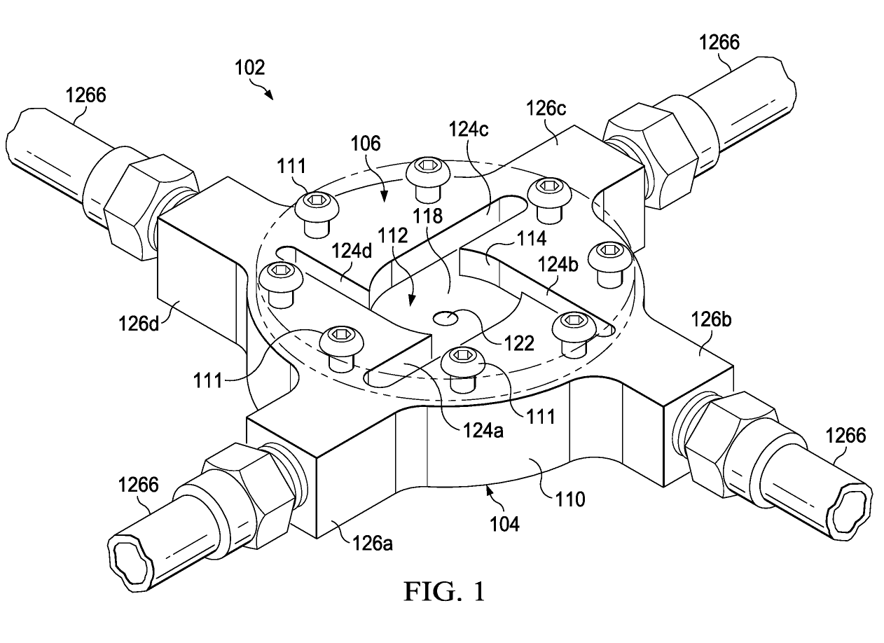

FIG. 1 is a perspective view of a mixing nozzle in accordance with an illustrative embodiment. Mixing nozzle 102 is an apparatus configured to mix seasoning ingredients to form a seasoning mixture before spraying the seasoning mixture onto one or more food pieces to create a seasoned food product. In one embodiment, the seasoning ingredients may be received into the mixing nozzle 102 as phase-separated ingredients. Phase separated ingredients are ingredients that are maintained in separate states. For example, a seasoning mixture that is formed from granulated solids and oil is received separately by the mixing nozzle 102 as an oil fraction and a solids fraction which are subsequently combined within the mixing chamber of the mixing nozzle. In another embodiment, the seasoning ingredients may be preliminarily mixed as they are introduced into the mixing nozzle 102. The preliminary mixing is often incomplete and results in clumpy, non-homogenous agglomeration that require further mixing within the mixing nozzle 102 prior to spraying. Furthermore, although the illustrative embodiments disclosed herein describe phase separated seasoning ingredients, the mixing nozzle described herein may be applied in other industries unrelated to food. Thus, the term “phase separated ingredients” may be used to describe inedible matter that may be mixed within the novel mixing nozzles described herein. For example, phase separated ingredients may be used to describe an oil base and colored particulate matter maintained separately, which can then be combined in mixing nozzle 102 to form an oil based paint that can then be sprayed onto a surface.

In this illustrative embodiment in FIG. 1, mixing nozzle 102 includes a housing 104 that is generally cylindrical in shape with a first exterior end 106 separated from a second exterior end by a curved, exterior sidewall 110. In an alternate embodiment where the mixing nozzle 102 has a cubed or box-like shape, the curved, exterior sidewall 110 may be replaced by four lateral sidewalls. The first exterior end 106 in this illustrative embodiment is a removable cover attached by a set of fasteners 111, which are screws in this example. Extending outwardly from the curved exterior sidewall 110 is a set of tangential inlet ports 126a, 126b, 126c, and 126d. The set of tangential inlet ports 126a, 126b, 126c, and 126d is one or more connection points that receive the terminal ends of a set of feed lines that convey seasoning ingredients and/or compressed air to the mixing nozzle 102. The set of tangential inlet ports 126a, 126b, 126c, and 126d may be integrally formed with or removably attached to the housing 104. In this non-limiting example, the set of tangential inlet ports 126a, 126b, 126c, and 126d is integrally formed with the curved sidewall 110, and each tangential inlet port is configured with a threaded receiver that engages the terminal end of a corresponding feed line from the set of feed lines 1266. In this example, the terminal end of each feed line is configured with a counter-threaded fastener that mates with the corresponding receiver so that each of the set of feed lines 1266 is securely, but removably connected to one of a set of tangential inlet ports 126a, 126b, 126c, and 126d. In other embodiments, other forms of fasteners may be implemented.

On occasion, relative terms may be used to describe parts or components of the mixing nozzles disclosed herein. Thus, in some instances the first exterior end 106 of the mixing nozzle 102 that receives the removable cover may also be referred to in the alternative as the top or upper portion of the mixing nozzle regardless of whether or not the mixing nozzle may be angled so that the first exterior end 106 is not the actual upper surface. Likewise, the second exterior end 108 of the mixing nozzle 102 that includes the opening 142 may be referred to in the alternative as the bottom or lower portion regardless of the actual orientation. Likewise, the terms “upstream” and “downstream” may also be used to describe the positions relative to the flow of seasoning ingredients. Further reference may be made to a horizontal reference plane to describe the relative orientation of the mixing nozzle or components of the mixing nozzle. As used herein, the horizontal reference plane is an imaginary plane that is not inclined and in many instances corresponds to a flat surface, such as a factory floor, on which the components of a seasoning system may be installed.

Housing 104 may be machined from a single block of food-grade metal, such as steel or aluminum. However, in alternate embodiments, the housing 104 may be formed from a variety of other materials, using any one of a number of known manufacturing techniques. For example, the housing 104 may be formed from thermoformed plastic, or constructed from a number of separate components that are subsequently joined together. Likewise, the cover that forms the first exterior end 106 may also be formed from any number of different materials. In this embodiment in FIG. 1, the cover is fashioned from a transparent material, such as acrylic, which facilitates the inspection of the inner workings of the mixing nozzle 102. However, the cover may be machined from the same material in which the body of the mixing nozzle 102 is formed.

Although the cover is attached to the housing 104 of the mixing nozzle 102 by a set of fasteners 111, in an alternate embodiment, the cover may be attached to mixing nozzle 102 using any type of currently existing or later developed means. For example, the cover and its set of fasteners 111 may be replaced by a threaded cap that can be screwed onto housing 104. In an alternate embodiment, the cover may be omitted entirely and replaced by an upper portion that is integrally formed with or permanently affixed to the housing 104.

Within the housing 104 is a mixing chamber 112. Mixing chamber 112 is a cavity having a generally cylindrical shape with a curved sidewall 114 connecting a first end 116 of the mixing chamber 112 with a second end 118. In this non-limiting embodiment, the first end 116 is open but is sealed by the removable cover. The second end 118 of the mixing chamber, which is located opposite from the first end 116, includes an exit orifice 122 that is preferably located in the center of the second end 118. The exit orifice 122 is one end of an exit channel 140 that has an downstream end that manifests as an opening 142 terminating outside of the mixing nozzle 102. Seasoning mixed within the mixing chamber 112 is expelled out from the mixing chamber 112 through exit orifice 122, passing through the exit channel 140, then out of the opening 142 before being deposited onto food pieces.

Although mixing chamber 112 is depicted as a cavity with a generally cylindrical shape, the shape of the mixing chamber 112 may vary depending upon the particular implementation. For example, the mixing chamber 112 may have a shape that is generally hemispherical or conical. Alternatively, the mixing chamber 112 may have a compound shape formed from two or more simple shapes. For example, the first end 116 and the curved sidewall 114 may define a cylindrical volume that is joined to the second end 118, which may have the shape of a hemisphere. The second end 118 may also take the form of a cone.

Extending tangentially from the mixing chamber 112 is a set of tangential feed conduits 124a, 124b, 124c, and 124d. The set of tangential feed conduits 124a, 124b, 124c, and 124d is one or more channels oriented tangentially, or at least substantially tangentially to the curved sidewalls of the mixing chamber 112 and provide a means of ingress for seasoning ingredients and/or pressurized air to enter the mixing chamber 112. Each of the set of tangential feed conduits 124a, 124b, 124c, and 124d has a first, downstream end that opens into the mixing chamber 112 and a second, upstream end that terminates on an outer surface of the mixing nozzle 102. The orientation of the set of tangential feed conduits 124a, 124b, 124c, and 124d relative to the curved sidewall 114 of the mixing chamber 112 facilitates the formation of a mixing vortex within the mixing chamber 112, which has a high shear mixing region capable of thoroughly mixing seasoning ingredients to form a seasoning mixture.

Each of the set of tangential feed conduits 124 is connected to a feed line by a corresponding tangential inlet port. In this illustrative embodiment in FIG. 1, the mixing nozzle 102 has four tangential feed conduits 124a, 124b, 124c, and 124d that coincide with tangential inlet ports 126a, 126b, 126c, and 126d, respectively. Additionally, each of the set of tangential feed conduits 124a, 124b, 124c, and 124d has a first end proximate to the mixing chamber 112 that is best described as a trough-shaped channel which transitions into a tubular conduit that passes through the housing 104 and terminates at the ends of their respective tangential inlet ports 104a, 104b, 104c, and 104d. In this embodiment, the trough-shaped portion of the tangential feed conduits is bounded on the upper side by the removable cover to form an enclosed channel. In an alternate embodiment, the set of tangential feed conduits 124a, 124b, 124c, and 124d may take the form of an entirely tubular channel fully enclosed by the housing 104 rather than partially enclosed by the housing 104 and partially enclosed by the cover 106. Alternatively, the set of tangential feed conduits may take the form of an entirely trough-shaped channel.

In one embodiment, the height of the curved sidewall 114 of the mixing chamber 112 is between 1-10 millimeters, and the diameter of the mixing chamber is between 5-27 millimeters. The exit orifice 122 has a diameter of 2-10 millimeters and a length of 5-30 millimeters. The outer diameter of the housing is 50-77 millimeters.

Seasoning ingredients are mixed within the mixing nozzle 102 by a mixing vortex that is formed within the mixing chamber 112 when compressed air is introduced into the mixing chamber 112 through the set of tangential feed conduits 126a, 126b, 126c, and 126d. The orientation of the tangential feed conduits 126a, 126b, 126c, and 126d relative to the mixing chamber 112, and in particular to the curved sidewall 114 of the mixing chamber 112, causes the compressed air to rotate within the chamber, forming a vortex. As the air is forced out of the exit orifice 122 located in the center of the second end 118, the velocity of the mixing vortex increases. Thus, the velocity of the vortex exhibits a velocity gradient that is inversely proportional to the radius of the mixing chamber 112. In other words, the velocity of the mixing vortex is lowest around the perimeter of the mixing chamber 112 and highest in the middle. The velocity of the mixing vortex within the exit channel is highest around the outer perimeter, along the curved walls of the exit channel. However, the velocity is lower in the center of the vortex within the exit channel.

Seasoning ingredients and/or compressed air may enter the mixing chamber 112 through the set of tangential feed conduits 124a, 124b, 124c, and 124d in any number of different combinations or permutations. In some embodiments, only compressed air and solid seasoning ingredients are fed into the mixing nozzle 102 from the set of tangential feed conduits. In other embodiments, only compressed air and liquid seasoning ingredients are fed into the mixing nozzle 102 from the set of tangential feed conduits. In other embodiments, half the tangential feed conduits feed solid seasoning ingredients into the mixing chamber 112 while the other half feeds liquid seasoning ingredients. The solid seasoning ingredients may be introduced into the mixing chamber 112 through adjacent tangential feed conduits, such as tangential feed conduits 124a and 124b, and oil may be introduced into the mixing chamber 112 through adjacent tangential feed conduits 124c and 124d. However, in an alternate embodiment, solids may be introduced into the mixing chamber 112 from oppositely positioned tangential feed conduits, such as tangential feed conduits 124a and 124c. Likewise, oil may be introduced into the mixing chamber from oppositely positioned tangential feed conduits, such as tangential feed conduits 124b and 124d. In another embodiment, more than half of the tangential feed conduits may introduce solid seasoning ingredients than liquid seasoning ingredients. In yet another embodiment, more than half of the tangential feed conduits may introduce liquid seasoning ingredients than solid seasoning ingredients. Furthermore, one or more of the tangential feed conduits 124a, 124b, 124c, and 124d may be configured to introduce only pressurized air into the mixing chamber 112.

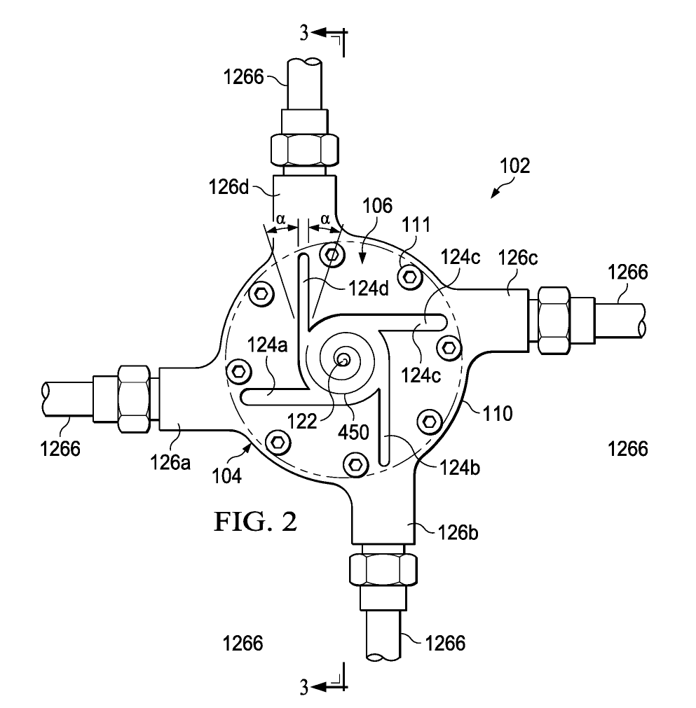

FIG. 2 is a top view of the mixing nozzle shown in FIG. 1. As can be seen, the first exterior end 106 is formed by a removable cover coupled to the remaining portion of the housing 104 by a set of fasteners 111. The mixing chamber 112 is located within the housing 104 and has a set of tangential feed conduits 124a, 124b, 124c, and 124d extending tangentially from the curved sidewall 114.

Although each of the set of tangential feed conduits 124a, 124b, 124c, and 124d are shown to extend tangentially from the mixing chamber 112, in an alternate embodiment, the set of tangential feed conduits 124a, 124b, 124c, and 124d are not perfectly tangential to the mixing chamber 112 but are substantially tangential to the mixing chamber 112. As used herein, the term “substantially tangential” means that the each tangential feed conduit 124a, 124b, 124c, and 124d may deviate from their tangential orientation shown in FIG. 2 by an angle alpha, which may be 5 degrees, or alternatively 10 degrees so long as the compressed air can generate a mixing vortex sufficient to thoroughly mix the seasoning ingredients within the mixing chamber 112.

Each of the set of tangential feed conduits 124a, 124b, 124c, and 124d are connected to a feed line by a corresponding tangential inlet port. In this non-limiting example, tangential feed conduit 124a is connected to feed line 1266 by tangential inlet port 126a, tangential feed conduit 124b is connected to feed line 1266 by tangential inlet port 126b, tangential feed conduit 124c is connected to feed line 1266 by tangential inlet port 126c, and tangential feed conduit 124d is connected to feed line 1266 by tangential inlet port 126d.

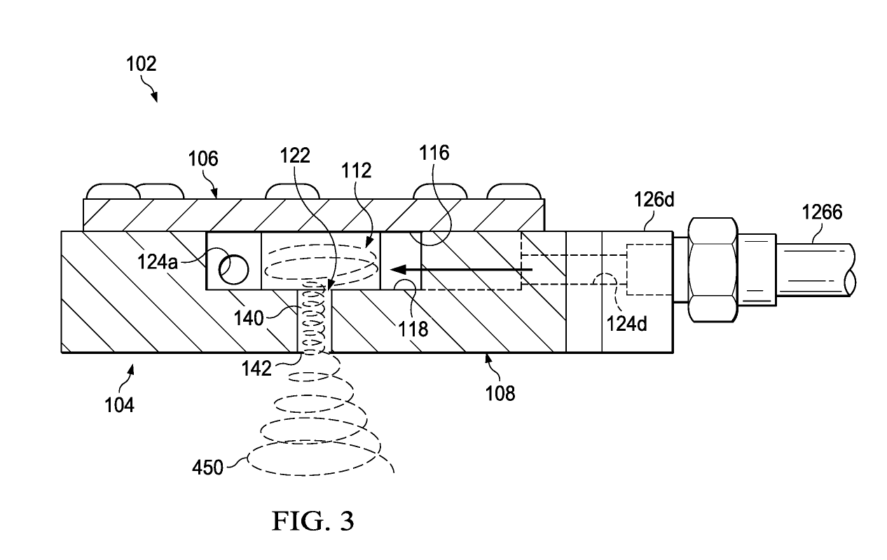

FIG. 3 is a cross-sectional view of the mixing nozzle of FIG. 2, taken along line 3. Mixing nozzle 102 has a housing 104 that defines a mixing chamber 112 bounded by a curved sidewall separating a first end 116 from a second end 118. In this non-limiting embodiment, the first end 116 is an open end that is bounded by a cover attached to the housing 104 by a set of fasteners 111. The second end 118 of the mixing chamber 112 is opposite and parallel from the first end 116 and includes a centrally located exit orifice 122 that is one end of an exit channel 140 that passes through the lower portion of housing 104. The second, downstream end of the exit channel 140 is an opening 142 located in the second exterior end 108 of the mixing nozzle 102. In this embodiment, the exit channel 140 has a uniform cross-sectional area; however, in alternate embodiments the exit orifice 122 has a smaller diameter than the opening 142 in the second exterior end 108.

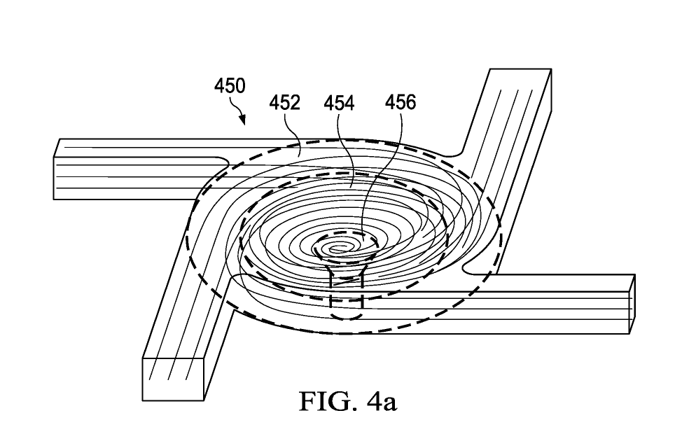

In this illustrative embodiment of FIG. 3, compressed air is the carrier that transports seasoning particles and oil into the mixing nozzle 102. Thus, compressed air enters the mixing chamber 112 through each of the set of tangential feed conduits 124a, 124b, 124c, and 124d. The compressed air forms a mixing vortex 450 having a velocity profile as shown in FIG. 4. The seasoning ingredients carried by the compressed air are mixed as they travel through the mixing chamber 112 towards the exit orifice 122, and in particular mixing is achieved in the high shear region of the mixing vortex 450, which generally coincides with the exit orifice 122. In particular, the high shear mixing region is located within the mixing chamber 112 and is a column of air that is concentric with the exit orifice 122, extending upwardly from and aligned with the exit orifice 122 and passes through the exit channel 122 and extends a distance outside of the mixing nozzle 102. The characteristics of the velocity profile, and of the high shear mixing region of the mixing vortex 450 is a function of the initial velocity of the compressed air entering the mixing chamber 112, the dimensions of the mixing chamber 112, and the dimensions of the exit channel 140, as can be seen in FIGS. 4a and 4b below.

FIG. 4a is an illustration of the flow path of compressed air traveling through a mixing nozzle in accordance with an illustrative embodiment. An outline of the mixing chamber 112 is shown along with portions of each of the tangential feed conduits 124a, 124b, 124c, and 124d. In this illustrative embodiment, compressed air entering into the mixing chamber 112 through the set of tangential feed conduits 124a, 124b, 124c, and 124d forms a mixing vortex 450. The mixing vortex 450 is depicted with three velocity regions: initial velocity region 452, intermediate velocity region 454, and high shear mixing region 456. The high shear mixing region 456 begins at or around the exit orifice 122, within the mixing chamber 112 and passes through the exit channel 122 and extends a distance outside of the mixing nozzle 102. In other embodiments, the compressed air may be introduced into fewer than all four of the set of tangential feed conduits. For example, seasoning ingredients may be fed into a mixing nozzle without the use of a gaseous carrier, in which case the flow path depicted in FIG. 4a would be changed accordingly to omit one or more sources of compressed air flowing into the mixing nozzle. Regardless, the general flow path of compressed air in the mixing chamber would remain the same, e.g., with an initial velocity region, an intermediate velocity region, and a high shear mixing region.

FIG. 4b is a graph depicting the velocity of moving particles versus a distance of the particles relative to the center of the mixing chamber in accordance with another illustrative embodiment. In this non-limiting embodiment, the mixing chamber 112 of the mixing nozzle 102 has a diameter of approximately 2 inches (5 centimeters) and the initial velocity of the compressed air entering the mixing chamber 112 is approximately 5 meters per second. Velocity of the mixing vortex 450 is shown on the y-axis and the radial distance of the mixing chamber 112 is shown on the x-axis. The zero value coincides with the outlet orifice 122. As can be seen, the initial velocity region corresponds with the regions between −1 to −0.5 and 0.5 to 1. The intermediate velocity region corresponds with the regions between −0.5 to −0.1 and 0.1 to 0.5. Lastly, the high shear mixing region corresponds to the regions between −0.1 to 0.1. The dimensions of the mixing nozzle are exemplary and non-limiting. One of ordinary skill in the art would recognize that the size of the mixing nozzle can be changed without departing from the spirit and the scope of the invention, and the size can be selected based upon a number of factors including flow rate and size constraints.

The high shear mixing region 456 is the portion of the mixing vortex 450 that has a velocity that is at least 4 times greater than the initial velocity region. In another embodiment, the high shear mixing region 456 has a velocity that is at least 8 times, at least 12 times, at least 16 times, or at least 20 times greater than the initial velocity region.

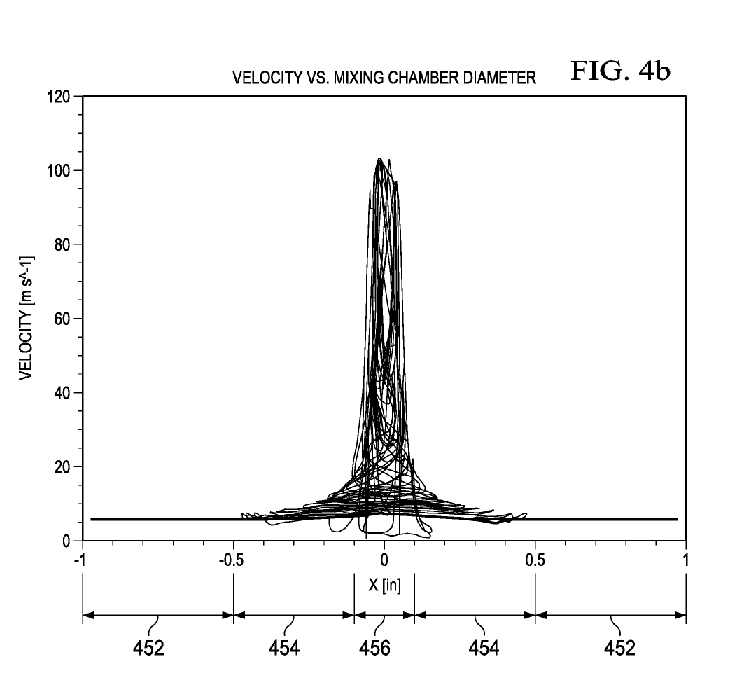

FIG. 5 is mixing nozzle in accordance with an alternate embodiment. The mixing nozzle 102 is configured with an axial feed line 1266′ connected to the first exterior end 106 of the housing 10, which introduces seasoning ingredients from an axial inlet orifice 120 at the first end 116 of the mixing chamber 112 in a direction that is perpendicular to the feed streams introduced through tangential feed conduits 124a, 124b, 124c, and 124d.

In the illustrative embodiment of FIG. 5, the axial inlet orifice 120 is positioned directly above the outlet orifice 122 to deposit seasoning ingredients into the high shear mixing region 456 of the mixing vortex 450. However, in another embodiment, the axial inlet orifice 120 may be positioned off-center and closer to the perimeter to introduce the seasoning ingredients and/or compressed air into either the initial velocity region 452 or the moderate velocity region 454. Depending on the velocity of the mixing vortex 450, the rotation of the mixing vortex 450 within the mixing chamber 112 may cause a negative pressure that may help pull the seasoning into the mixing chamber 112 from the axial inlet orifice 120. In some embodiments, the negative pressure can suffice to help pull the seasoning ingredients into the mixing chamber in the event that the storage vessels are maintained at atmospheric pressure.

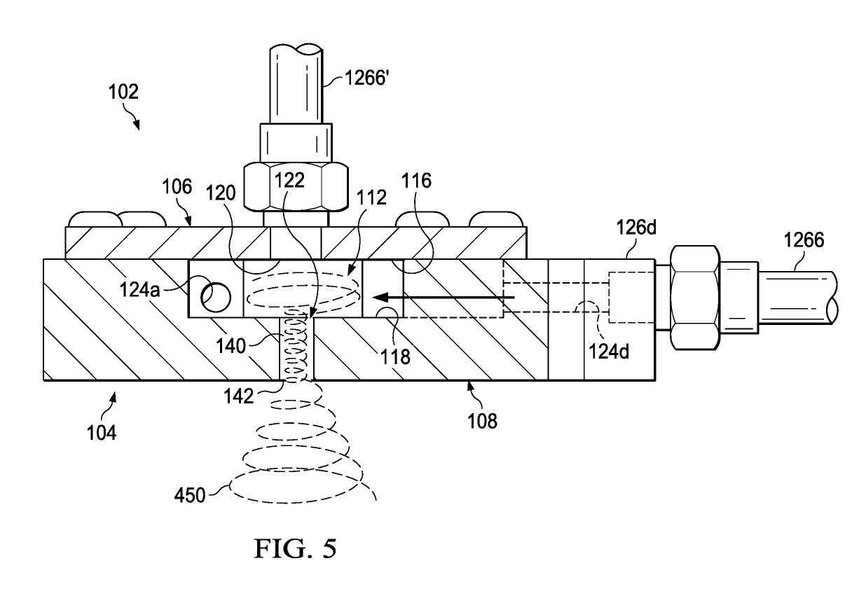

FIG. 6 is a perspective view of a mixing nozzle in accordance with an alternate embodiment. Mixing nozzle 602 receives phase-separated ingredients into an interior mixing chamber to form a seasoning mixture before spraying the seasoning mixture onto food pieces to form seasoned food pieces. In this illustrative embodiment, mixing nozzle 602 includes a housing 604 that is generally cubic in shape. The housing 604 has a first exterior end 606 opposite and parallel to a second exterior end 608, separated by four lateral sides 610a, 610b, 610c, and 610d. In an alternate embodiment where mixing nozzle 602 is cylindrical, a curved sidewall replaces the four lateral sides to separate the first exterior end 606 from the second exterior end 608.

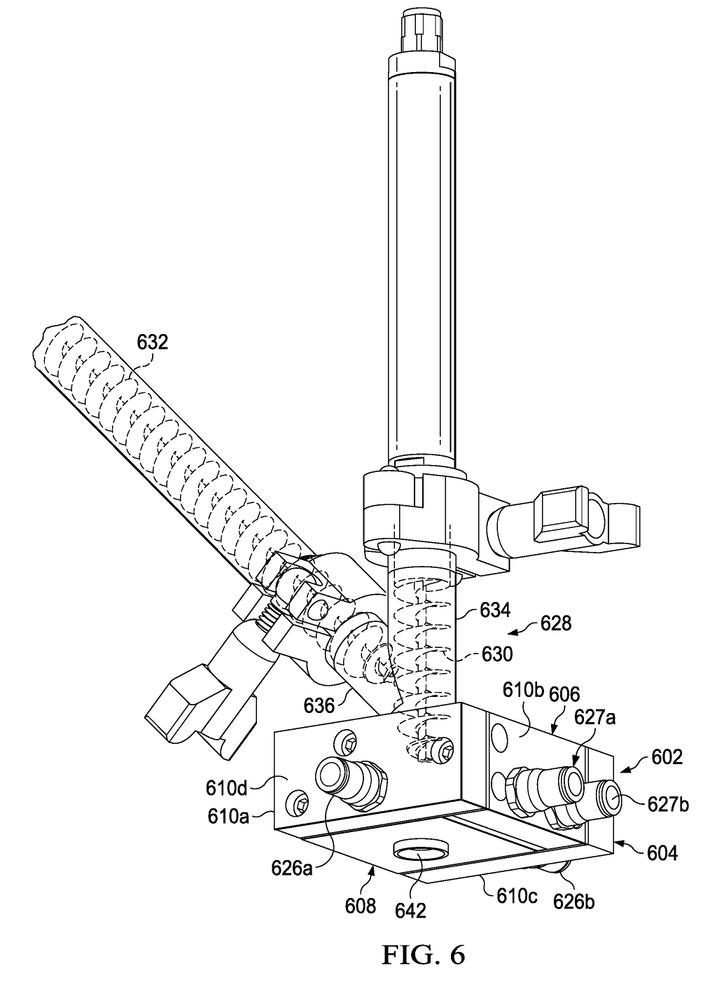

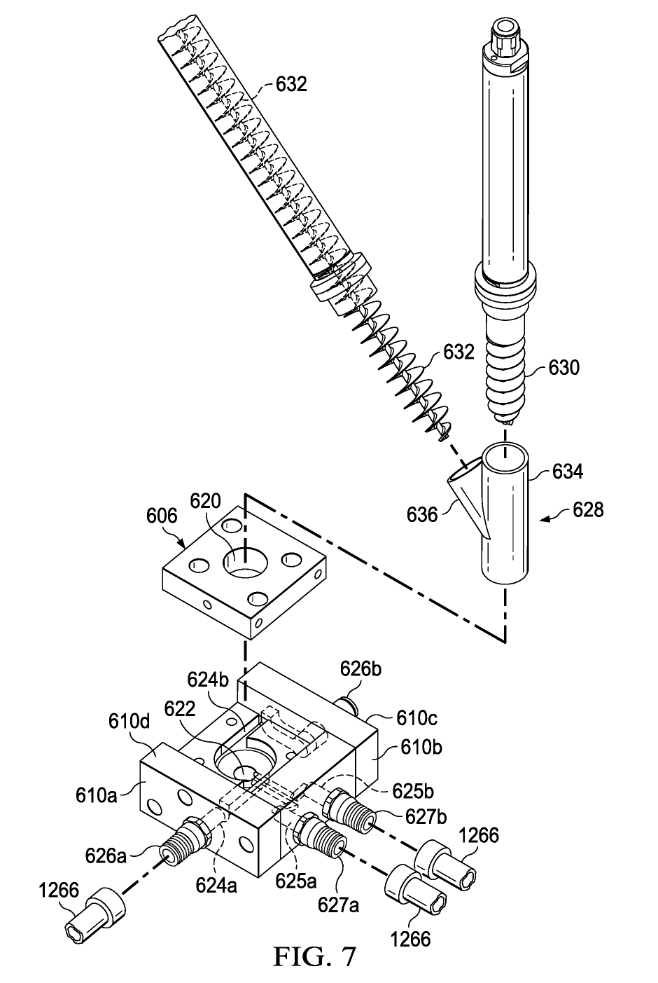

Projecting outwardly from one or more of the four lateral sides 610a, 610b, 610c, and 610d of mixing nozzle 602 is a set of tangential inlet ports. The set of tangential inlet ports 626a, 626b, and 626c is one or more connection points that connects a tangential feed conduit (shown in more detail in FIGS. 7 and 8) with one or more of a set of feed lines, such as feed lines 1266. The set of tangential inlet ports may include any number of ports depending upon the particular implementation; however, in the non-limiting embodiment depicted in FIG. 6, the set of tangential inlet ports includes only two tangential inlet ports 626a and 626b.

Also projecting outwardly from one or more of the four lateral sides of the mixing nozzle 602 is a set of optional high shear inlet ports 627. The set of high shear inlet ports, which includes high shear inlet ports 627a and 627b, are connectors that receive the terminal end of a feed line for introducing seasoning ingredients and/or pressurized air directly into the high shear mixing region of a mixing vortex. In particular, each of the set of high shear inlet ports 627 connects a feed line with a high shear feed conduit 625 that passes through the housing 604 and into the exit channel 640, as shown in FIGS. 7 and 8. Introduction of seasoning ingredients directly into the high shear mixing region provides more efficient mixing.

Attached to a first exterior end 606 of the mixing nozzle 602 is an auger coupling 628. The auger coupling 628 is a connection device that connects one or more enclosed feed augers to the mixing nozzle 602. The auger coupling 628 may be removably attached to, or integrally formed with the first exterior end 606. In this illustrative embodiment, the auger coupling 628 is configured to accommodate a set of feed augers that includes two augers, primary feed auger 630 and secondary feed auger 632. The primary feed auger 630 is an auger that is oriented normally, or at least substantially normally, to the first exterior end 606 and is positioned to introduce seasoning ingredients into a mixing chamber 612 of the mixing nozzle 602. As used herein, the term “substantially normally” means that the primary feed auger 630 is oriented at an angle that is closer to vertical than horizontal. Thus, the primary feed auger 630 may be at an angle that is greater than 45 degrees relative to the first exterior end 606 of the mixing nozzle 602.

In some instances, depending upon location and orientation of the mixing nozzle relative to the seasoning tank (not shown), a secondary feed auger 632 may be necessary to convey the seasoning particles from the storage vessel to the mixing nozzle. For example, if mixing nozzle 602 is oriented with the first and second exterior ends 606 and 608 parallel to a horizontal reference plane, and the seasoning tank were located directly above the mixing nozzle 602, then the primary feed auger 630 would be sufficient to convey seasoning particles from the seasoning tank to the mixing nozzle 602 and into the mixing chamber 612. In this example, gravitational forces may even suffice to convey the seasoning particles from the seasoning tank to the mixing nozzle 602, rendering the secondary feed auger 630 unnecessary. In other embodiments, the feed augers may be replaced by compressed air or other transfer means. Notwithstanding, the embodiment depicted in FIG. 6 includes an auger coupling 628 that is capable of accommodating both a primary feed auger 630 and a secondary feed auger 632.

Auger coupling 628 has a trunk 634 that is attached to the first exterior end 606 of the mixing nozzle 602, which maintains the primary feed auger 630 in the normal or substantially normal orientation. The trunk 634 is sized to house at least a portion of the primary feed auger 630 and may be removably attached to or integrally formed with the first exterior end 606. In this non-limiting embodiment, the primary feed auger 630 extends through the trunk 634 and at least partially into the mixing chamber 612. The trunk 634 is oriented perpendicularly, or at least substantially perpendicularly to the first end 606.

Located at the second exterior end 608 of the mixing nozzle 602 is an opening 642, which is the downstream end of an exit channel 640 that passes through the housing 604 from the mixing chamber 612 to the exterior environment. Seasoning ingredients mixed within the mixing chamber 612 are expelled through the exit orifice 622, through the length of the exit channel 640, and out the opening 642 to coat a food piece. In this embodiment, the opening 642 has a diameter that is larger than the diameter of the exit orifice, resulting in an exit channel 640 that has a flared downstream end. However, in alternate embodiments, the exit channel 640 has a uniform cross-sectional area throughout its entire length.

FIG. 7 is a perspective view of the mixing chamber 612 of the mixing nozzle depicted in FIG. 6. The first exterior end 606 of the housing 604 is separated from the second exterior end 608 to expose the mixing chamber 612 within. Mixing chamber 612 is a cavity with a generally cylindrical shape. A first end of the mixing chamber 612 is separated from the second end 618 by a curved sidewall 614. As previously discussed, the shape of the mixing chamber may vary depending upon the particular implementation. For example, the mixing chamber 612 may have a shape that is generally hemispherical or conical. Alternatively, the mixing chamber 612 may have a compound shape formed from two or more simple shapes. For example, the first end of the mixing chamber 612 and the curved sidewall 614 may define a cylindrical volume that is joined to the second end 618, which may have the shape of a hemisphere. The second end 618 may also take the form of a cone.

In this illustrative embodiment, the first end 616 of the mixing chamber includes an axial inlet orifice 620 that provides a means of ingress for seasoning ingredients into the mixing chamber 612. The second end 618 includes an exit orifice 622 from which the seasoning mixture may be expelled. Exit orifice 622 is a first end of an exit channel 640 that passes from the mixing chamber 612 to the exterior surface of the mixing nozzle 602, which is manifested as an opening 642 at the second exterior end 608 as can be seen in more detail in FIG. 6. In this illustrative embodiment in FIG. 6, the opening 642 at the downstream end of the exit channel 640 has a larger diameter than the outlet orifice 622.

A set of tangential feed conduits 624a and 624b extends tangentially, or at least substantially tangentially from the curved sidewall 614 of the mixing chamber 612. A first, downstream end of each of the tangential feed conduits 624a and 624b is an opening in the curved sidewall 614 of the mixing chamber 612. The second, upstream end of each of the tangential feed conduits 624a and 624b is an opening on the exterior surface of the mixing nozzle which is coupled to a corresponding feed line by a tangential inlet port. In this illustrative example, tangential feed conduit 624a is connected to feed a line 1266 by tangential inlet port 626a, and tangential feed conduit 624b is connected to feed line 1266 by tangential inlet port 626b. The set of feed lines 1266 may provide seasoning ingredients and/or compressed air into the mixing chamber 612.

The mixing nozzle 602 may include a set of optional high shear feed conduits 625. The set of high shear feed conduits 625 is one or more channels with a first, downstream end that opens into the exit channel 640, and an upstream end that is an opening on the exterior surface of the mixing nozzle 602. In this embodiment in FIG. 6, the high shear feed conduits 625a and 625b are connected to feed lines 1266 by high shear inlet ports 627a and 627b. Seasoning ingredients fed into the mixing nozzle 602 through the high shear feed conduits 625a and 625b are injected directly into the high shear region of the mixing vortex. As can be seen, high shear inlet port 627b connects a feed line with an opening in the upper end of the exit channel 640. High shear inlet port 627a connects a feed line with an opening in the exit channel 640 downstream from the opening associated with the high shear inlet port 627b. A feed line may be connected to one or both of the high shear inlet ports 627 depending upon the particular implementation for introducing seasoning ingredients or compressed air. Seasoning ingredients may be introduced into one or both of the high shear inlet ports 627 based upon desired atomization effects. For example, the velocity of the mixing vortex is at the upper end of the exit channel 640, which would provide greater atomization effects compared to the atomization effects at a downstream end of the exit channel 640. Atomization effects may also be controlled by the aperture size and pressure in the feed line.

FIG. 8 is a cross-sectional view of the mixing nozzle depicted in FIG. 6, illustrating the mixing of seasoning ingredients to form a sprayable seasoning mixture in accordance with an illustrative embodiment. In this illustrative embodiment, compressed air is introduced into the mixing chamber through each of the tangential feed lines 1266, each of which is connected to the mixing nozzle 602 through a set of tangential inlet ports 626a and 626b. In this illustrative embodiment, the feed line 1266 connected to the tangential inlet port 626a is fitted with a T-coupling that connects the feed line 1266 with an oil feed line. Thus, the compressed air feeding into the mixing chamber 612 through the set of tangential feed conduits 624a and 624b creates a mixing vortex 450 within the mixing chamber that includes atomized oil. Solid seasoning ingredients are fed down into the axial inlet 620 located in the first end 616 of the mixing chamber 612. In this illustrative embodiment, the solid seasoning ingredients are fed into the mixing chamber 612 by the primary feed auger 630, which receives the solid seasoning ingredients from a secondary feed auger 632. The solid seasoning ingredients 680 are mixed with the oil 682 in the mixing chamber 612 by the mixing vortex 450, and in particular by the high shear mixing region that begins within the mixing chamber 612 and extends partially outside the mixing nozzle 602. The seasoning mixture is then expelled from the mixing chamber 622, through the exit channel 640 and out of the opening 642 to coat a food piece (not shown).

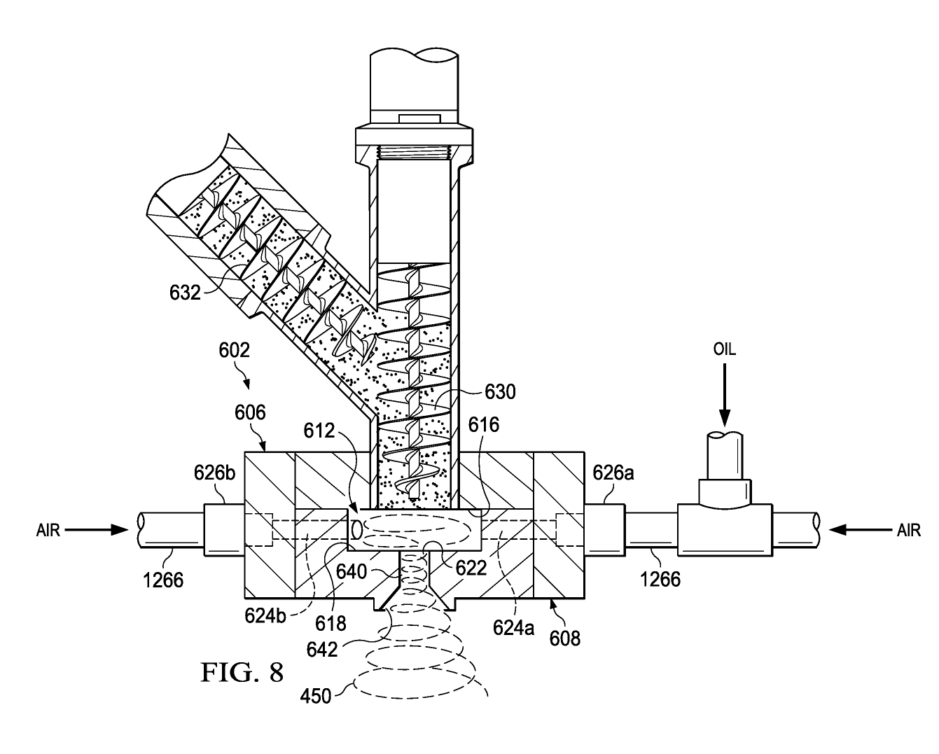

FIG. 9 is a perspective view of a mixing nozzle in accordance with another illustrative embodiment. Mixing nozzle 902 mixes seasoning ingredients within an interior mixing chamber to form a seasoning mixture before spraying the seasoning mixture onto food pieces to form seasoned food pieces. Mixing nozzle 902 includes a housing 904 that is generally cylindrical in shape with a first exterior end 906 separated from a second exterior end 908 by a curved, exterior sidewall 910. In an alternate embodiment where the mixing nozzle 902 has a cubic or box-like shape, the curved, exterior sidewall 910 may be replaced by four lateral sidewalls. In either embodiment, within the housing 904 is a mixing chamber 912.

In this non-limiting embodiment, mixing chamber 912 is a cavity having a generally cylindrical shape with a curved sidewall 914 connecting a first end 916 of the mixing chamber 912 with a second end 918. The first end 916 includes an axial inlet orifice 920 that provides a means of ingress for seasoning ingredients into the mixing chamber 912 and the second end 918 includes an exit orifice 922 from which the seasoning mixture may be expelled.

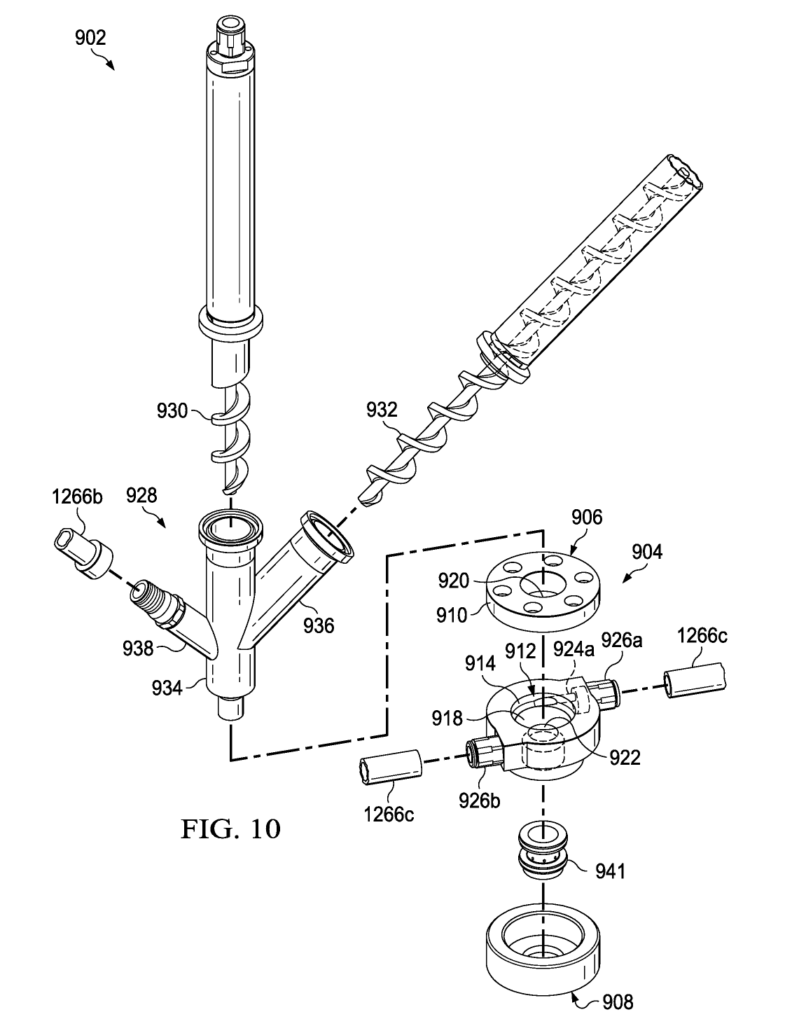

Extending tangentially from the mixing chamber 912 is a set of tangential feed conduits 924, which is shown in more detail in FIG. 11. The set of tangential feed conduits 924 is one or more channels oriented tangentially, or at least substantially tangentially to the curved sidewalls of the mixing chamber 912 as previously described in FIG. 2 above. Each of the set of tangential feed conduits 924 has a first, downstream end that opens into the mixing chamber 912 and a second, upstream end that terminates outside the mixing nozzle 902. The set of tangential feed conduits 924 provide a passage for seasoning ingredients and/or compressed air to enter the mixing chamber 912. As previously described, the orientation of the set of tangential feed conduits 924 relative to the curved sidewall 914 of the mixing chamber 912 facilitates the formation of a mixing vortex within the mixing chamber 912, which has a high shear mixing region capable of efficiently mixing seasoning ingredients to form a seasoning mixture.

Each of the set of tangential feed conduits 924 is connected to a feed line by a corresponding tangential inlet port. The set of tangential inlet ports 926 is one or more connection points that connects a tangential feed conduit with a feed line. In this illustrative embodiment in FIG. 9, the mixing nozzle 902 has two tangential feed conduits 924a and 924b that coincides with tangential inlet ports 926a and 926b, respectively. In this particular example, the feed lines carry air from an air compressor (not shown) to the mixing nozzle 902. The compressed air forms a mixing vortex within the mixing chamber 912.

Attached to a first exterior end 906 of the mixing nozzle 902 is an auger coupling 928. The auger coupling 928 is a connection device that connects one or more enclosed feed augers to the mixing nozzle 902. The auger coupling 928 may be removably attached to, or integrally formed with the first exterior end 906. In this illustrative embodiment, the auger coupling 928 is configured to accommodate a set of feed augers that includes two augers, primary feed auger 930 and secondary feed auger 932. The primary feed auger 930 is an auger that is oriented normally, or at least substantially normally, to the first exterior end 906 and is configured to introduce seasoning ingredients into a mixing chamber 912 of the mixing nozzle 902.

In some instances, depending upon location and orientation of the mixing nozzle relative to the seasoning tank (not shown), a secondary feed auger 932 may be necessary to convey the seasoning particles from the storage vessel to the mixing nozzle. For example, if mixing nozzle 902 was oriented with the first and second exterior ends 906 and 908 parallel to a horizontal reference plane, and the seasoning tank were located directly above the mixing nozzle 902, then the primary feed auger 930 would be sufficient to convey seasoning particles from the seasoning tank to the mixing chamber 912. In that example, the force of gravity may suffice to convey the seasoning particles from the seasoning tank to the mixing nozzle 902, rendering the secondary feed auger unnecessary. In other embodiments, the feed augers may be replaced by compressed air or other means of transfer. Notwithstanding, the embodiment depicted in FIG. 9 includes an auger coupling 928 that is capable of accommodating both a primary feed auger 930 and a secondary feed auger 932.

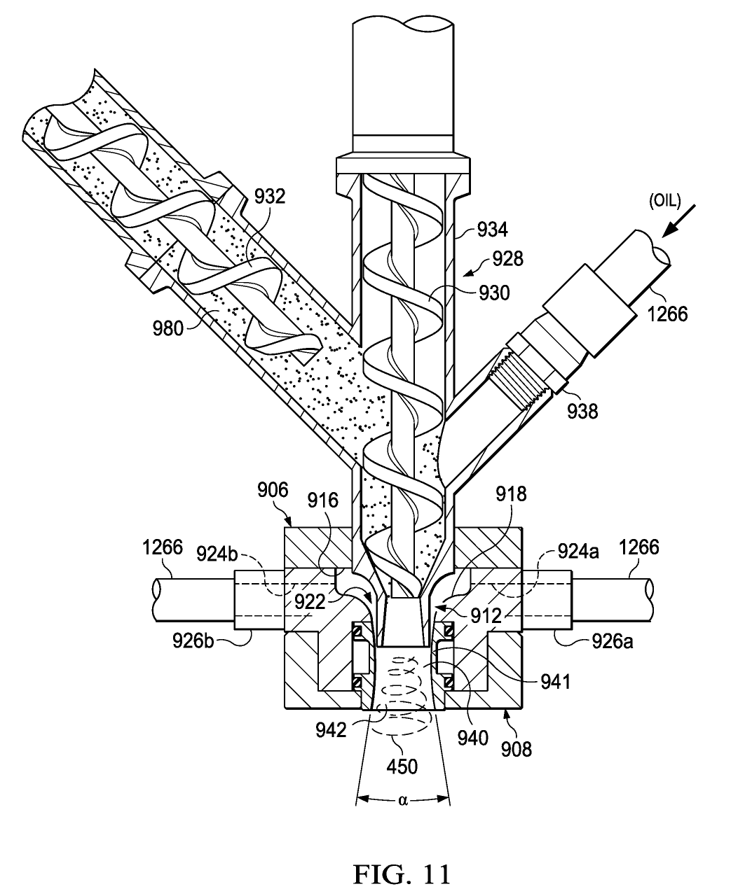

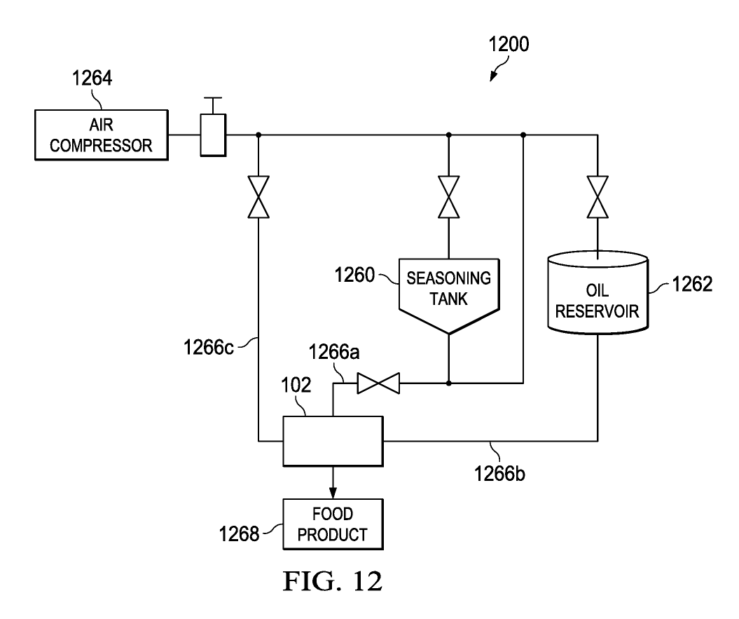

Auger coupling 928 has a trunk 934 that is attached to the first exterior end 906 of the mixing nozzle 902, which maintains the primary feed auger 630 in the normal or substantially normal orientation. The trunk 934 is sized to house at least a portion of the primary feed auger 930 and may be removably attached to or integrally formed with the first exterior end 906. The trunk 934 is oriented perpendicularly, or at least substantially perpendicularly to the first end 906, and may optionally include a branch 936 that receives the secondary feed auger 932 in those embodiments where an additional auger is necessary. Auger coupling 928 also includes a liquid inlet port 938, which is a connection point that receives the terminal end of a feed line 966b that is in fluid communication with a liquid reservoir (not shown), such as an oil reservoir depicted in FIGS. 12 and 13. In this illustrative embodiment, oil may be conveyed to the mixing nozzle 902 by a feed line coupled to the liquid inlet port 938. Additionally, oil and solid seasoning particles are preliminarily mixed before introduction into a mixing chamber 912 of mixing nozzle 902. Specifically, the oil and solid seasoning particles are mixed within the downstream end of the trunk 934 of the auger coupling 928 before the primary feed auger 930 pushes the partially mixed agglomeration of oil and solid seasoning particles into the mixing chamber 912 through the axial inlet orifice 920 for final mixing.

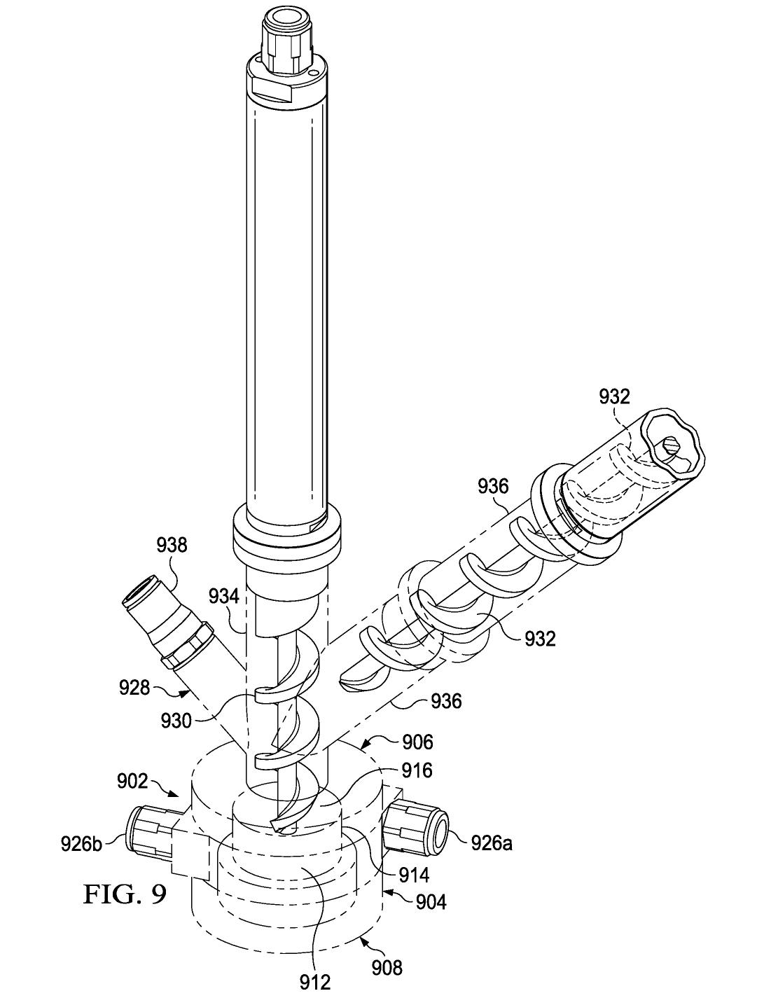

FIG. 10 is a perspective view of the mixing nozzle depicted in FIG. 9 in which the first exterior end 906 of the housing 904 is separated from the second exterior end 908 to expose the mixing chamber 912 within. Mixing chamber 912 is a cavity with a generally cylindrical shape. A first end 916 of the mixing chamber 912 is separated from the second end 918 by a curved sidewall 914. As previously discussed, the shape of the mixing chamber may vary depending upon the particular implementation. In some embodiments the mixing chamber 912 may have a shape that is generally hemispherical or conical. Alternatively, the mixing chamber 912 may have a compound shape formed from two or more simple shapes. For example, the first end 916 and the curved sidewall 914 may define a cylindrical volume that is joined to the second end 918, which may have the shape of a hemisphere. The second end 918 may also take the form of a cone or a similarly tapered shape.

Tangential feed conduit 924 extends tangentially, or at least substantially tangentially from the curved sidewall 914 of the mixing chamber 912. A first, downstream end of the tangential feed conduit 924 manifests as an opening in the curved sidewall 914 of the mixing chamber 912. The second, upstream end of the tangential feed conduit 924 is an opening on the exterior surface of the mixing nozzle which is coupled to a feed line by a tangential inlet port. In this illustrative example, tangential feed conduit 924 is connected to feed line 1266 by tangential inlet port 926. The feed line 1266 provides compressed air to the mixing nozzle 902 to form a mixing vortex 450 within the mixing chamber 912.

During operation, oil is conveyed to the mixing nozzle 902 by feed line that is connected to the trunk 934 of auger coupling 928 by liquid inlet port 938. Solid seasoning ingredients may be conveyed to the mixing nozzle 902 from a seasoning tank by a secondary auger 932, which is connected a trunk 934 of the auger coupling 928 by a branch 936. The seasoning ingredients are introduced into the mixing chamber 912 through an axial inlet orifice 920 by a primary feed auger 930 for mixing in the mixing vortex 450 that is formed from the compressed air entering through tangential feed conduit 924. The seasoning mixture is then expelled from the outlet orifice 922 for spraying onto a food piece.

In this illustrative embodiment of FIG. 10, mixing nozzle 902 includes a nozzle insert 941 that is maintained within the housing 904 downstream from the mixing chamber 912. The nozzle insert 941 is a removable component defining an exit channel 940 passing through from one end to the other. Different nozzle inserts may have different exit channel dimensions to control spray characteristics of seasoning mixtures expelled from the mixing nozzle 902. The nozzle insert 941 is described in more detail in FIG. 11 below.

FIG. 11 is a cross-sectional view of the mixing nozzle depicted in FIG. 9 illustrating the mixing of seasoning ingredients to form a sprayable seasoning mixture in accordance with an illustrative embodiment. Tangential inlet ports 926 are connected to feed lines 1266 that provides compressed air to the mixing nozzle 902. The orientation of the tangential feed conduits 924 relative to the mixing chamber 912 enables the compressed air to form a vortex 450 within the mixing chamber that accelerates as the air is forced out of the outlet orifice 922. The mixing vortex 450 formed within the mixing chamber 912 has a velocity profile as shown in FIG. 4, which is characterized by an initial velocity region around the perimeter of the mixing chamber 912, an intermediate velocity region, and a high shear velocity region that corresponds to and is concentric with the exit orifice 922 in the second end 918 of the mixing chamber 912. Depending on the velocity of the mixing vortex 450, the rotation of the mixing vortex 450 within the mixing chamber 112 may cause a negative pressure that may help pull the seasoning into the mixing chamber 112 from the axial inlet orifice 120.

Solid seasoning particles 980 and oil 982 are preliminarily mixed in the auger coupling 928 before the primary feed auger 930 feeds the partially mixed seasoning ingredients into the mixing chamber via the axial inlet orifice 920 in the first end 916 of the mixing chamber 912. Oil is introduced into the auger coupling 928 via a feed line 1266 connected to the auger coupling by liquid inlet port 938. Although the solid seasoning particles 980 may be conveyed into the auger coupling 928 by either the primary feed auger 930 or the secondary feed auger 932, in this particular embodiment, the secondary feed auger 932 provides the solid seasoning particles 980 from a seasoning tank while the primary feed auger 930 pushes the partially mixed seasoning ingredients into the mixing chamber 912.

The seasoning mixture exits the mixing chamber 912 from the exit orifice 922, travels the length of the exit channel 940 and passes out through an opening 942 in the second exterior end 908 to coat food pieces to form seasoned food pieces. The opening 942 has a diameter that is larger than the diameter of the exit orifice, resulting in an exit channel 940 that has a flared downstream end. However, in alternate embodiments, the exit channel 940 has a uniform cross-sectional area throughout its entire length.

In this illustrative embodiment of FIG. 11, the exit channel 940 is located within nozzle insert 941 so that different exit channels may be substituted into the mixing nozzle 902 by changing out the nozzle insert 941 with an exit channel with different dimensions. Two dimensions that have been shown to contribute to spray characteristics are channel length and angle of divergence at the downstream end of the exit channel, which determines the degree of which the exit channel is flared. In some embodiments, the length of the exit channel 940 within the nozzle insert 941 is between 0.635-4.45 cm (0.25-1.75 in), and the angle of divergence, α, may be up to 90°, or up to 75°, or in some embodiments up to 45°.

FIG. 12 is an exemplary system for coating a food piece with a seasoning mixture in accordance with an illustrative embodiment. System 1200 includes a mixing nozzle 102 that mixes seasoning ingredients within an internal mixing chamber to form the seasoning mixture before spraying the seasoning mixture onto food pieces to form seasoned food pieces. The seasoning ingredients are stored in phase-separated states. Specifically, solid seasoning ingredients are maintained in seasoning tank 1260 separate from the liquid ingredients, which are maintained in the oil reservoir 1262.

In this illustrative embodiment, seasoning tank 1260 is depicted as a single vessel; however, in alternate embodiments the seasoning tank 1260 may be two or more vessels. For example, a seasoning mixture may be a proprietary blend of two or more different types of solid seasoning ingredients. Each of the different types of solid seasoning ingredients may be stored separately in different seasoning tanks and separately fed into the mixing nozzle 102 for mixing into the proprietary blend. Alternatively, the two or more different types of solid seasoning ingredients may be pre-mixed and stored together in seasoning tank 1260. Similarly, oil reservoir 1262 is depicted as a single vessel that stores the liquid fraction of the seasoning mixture. In alternate embodiments, the oil reservoir 1262 may be two or more different reservoirs, each of which stores a different liquid that forms the liquid fraction of the seasoning mixture.

Seasoning tank 1260 and oil reservoir 1262 are connected to the mixing nozzle 102 by a set of feed lines 1266. The set of feed lines may be rigid or flexible pipes or tubing extending from one of the storage vessels to an inlet port, such as a tangential inlet port or an axial inlet port of the mixing nozzle 102. Seasoning ingredients maintained in the set of storage vessels are conveyed through the set of feed lines 1266 by a carrier, which is compressed air in this example. The compressed air is provided by air compressor 1264. In other embodiments, compressed air may be replaced by another gaseous carrier commonly used in the production of foodstuffs, such as nitrogen.

The seasoning ingredients are mixed within a mixing chamber of mixing nozzle 102 by a mixing vortex generated by the compressed air. In some embodiments, the mixing vortex may be wholly generated by compressed air feeding directly to the mixing nozzle through set of feed lines 1266. In other embodiments, the mixing vortex may be generated in whole or in part by compressed air carrying seasoning ingredients from their respective storage vessels to the mixing nozzle 102. After mixing, the mixing nozzle 102 sprays the seasoning mixture onto a food piece 1268. In one embodiment, the food piece 1268 may be conveyed to a position below the mixing nozzle 102 on an endless conveyor. In another embodiment, the food piece 1268 may be rotated in a mixing drum while the seasoning mixture is applied.

FIG. 13 is an exemplary system for coating a food piece with a seasoning mixture in accordance with another illustrative embodiment. The system 1300 includes a mixing nozzle 1302, which may take the form of mixing nozzle 602 or mixing nozzle 902, depending upon the particular implementation. The mixing nozzle 1302 mixes seasoning ingredients within a mixing chamber to form the seasoning mixture before spraying the seasoning mixture onto food pieces to form seasoned food pieces. The seasoning ingredients are stored in phase-separated states. Specifically, solid seasoning ingredients are maintained in seasoning tank 1260 separate from the liquid ingredients, which are maintained in the oil reservoir 1262.

In this illustrative embodiment, seasoning tank 1260 is depicted as a single vessel; however, in alternate embodiments the seasoning tank 1260 may be two or more vessels. For example, a seasoning mixture may be a proprietary blend of two or more different types of solid seasoning ingredients. Each of the different types of solid seasoning ingredients may be stored separately in different seasoning tanks and separately fed into the mixing nozzle 1302 for mixing into the proprietary blend. Alternatively, the two or more different types of solid seasoning ingredients may be pre-mixed and stored together in storage tank 1260. In either event, solid seasoning ingredients are conveyed from the seasoning tank 1260 to the mixing nozzle 1302 through a feed line 1266a. In one embodiment, feed line 1266 is a flexible or rigid tube connected to or at least partially housing a supplemental feed auger that introduces the solid seasoning ingredients into the auger coupling connected to the mixing nozzle 1302. In another embodiment, the feed line is connected to or at least partially houses a primary feed auger and is connected to the auger coupling to provide solid seasoning particles to the mixing nozzle 1302. Seasoning tank 1260 may be optionally pressurized to facilitate the movement of seasoning particulates from seasoning tank 1260 to mixing nozzle 1302 through feed line 1266a. Thus, the dotted line extending from the air compressor 1264 to the seasoning tank 1260 represents the optional compressed air line.

Oil reservoir 1262 is depicted as a single vessel that stores the liquid fraction of the seasoning mixture. In alternate embodiments, the oil reservoir 1262 may be two or more different reservoirs, each of which stores a different liquid that forms the liquid fraction of the seasoning mixture. In either event, the liquid fraction of the seasoning mixture may be pumped from the oil reservoir 1262 by pump 1367 to the mixing nozzle 1302 through a set of feed lines 1266b. The set of feed lines 1266b may be connected to a liquid inlet port extending out from an auger coupling, or from an exterior sidewall of the mixing nozzle. In addition, or in the alternative, oil may be blended with compressed air before introduction into the mixing nozzle. Thus, oil pumped from oil reservoir 1262 may flow through feed line 1266b′ instead of feed line 1266b, or may flow through feed line 1266b′ in addition to feed line 1266b.

The seasoning ingredients are mixed within a mixing chamber of mixing nozzle 1302 by a mixing vortex generated by compressed air provided by air compressor 1264. In some embodiments, the mixing vortex may be wholly generated by compressed air feeding directly to the mixing nozzle through set of feed lines 1266c. In other embodiments, the mixing vortex may be generated in whole or in part by compressed air carrying seasoning ingredients from their respective storage vessels.

Depending upon the particular configuration of the mixing nozzle 1302, the seasoning ingredients may be wholly mixed within a mixing chamber of the mixing nozzle 1302, or the seasoning ingredients may be partially mixed outside the mixing chamber while in transit, immediately before the seasoning ingredients are fully mixed within the mixing chamber as shown in FIG. 11. After mixing, the mixing nozzle 1302 sprays the seasoning mixture onto a food piece 1368. In one embodiment, the food piece 1368 may be conveyed to a position below the mixing nozzle 1302 on an endless conveyor. In another embodiment, the food piece 1368 may be rotated in a mixing drum while the seasoning mixture is applied.

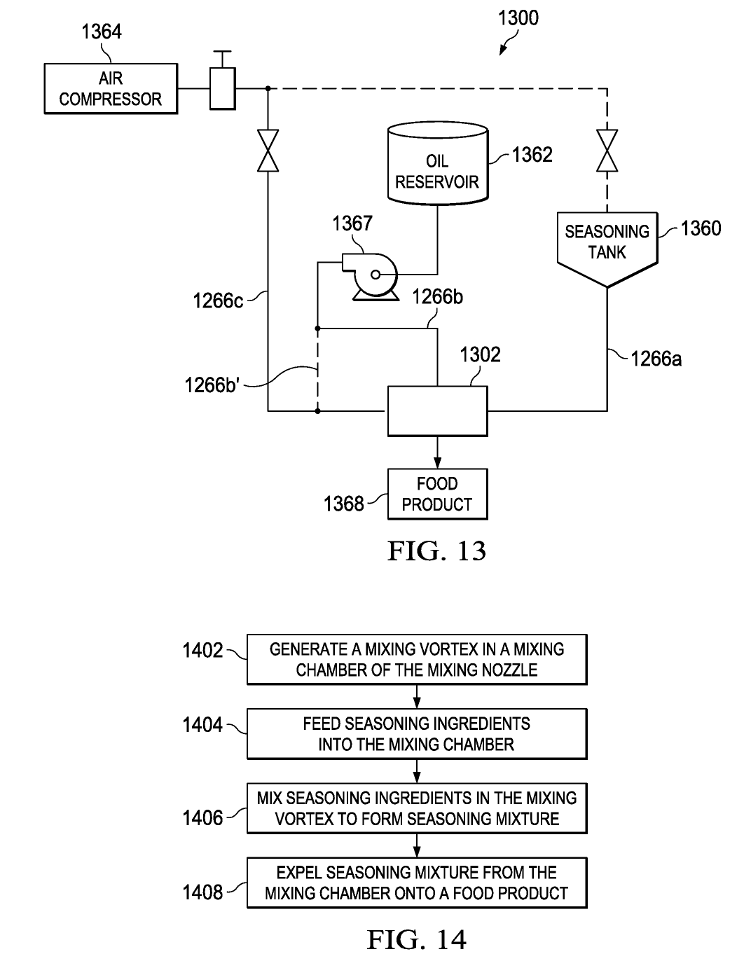

FIG. 14 is a flowchart of a process for coating a food product with seasoning in accordance with an illustrative embodiment. The process can be implemented in a mixing nozzle, such as mixing nozzle 102 in FIG. 1, mixing nozzle 602 in FIG. 6, or mixing nozzle 902 in FIG. 9.

A mixing vortex is generated in a mixing chamber of the mixing nozzle (step 1402). As previously discussed, the mixing vortex is generated by introducing compressed air into the mixing chamber by a set of tangential feed conduits. The compressed air may be introduced into the mixing chamber by itself, or the compressed air may serve as a carrier of a seasoning ingredient, such as atomized oil particles or solid seasoning particles.

The process then feeds seasoning ingredients into the mixing chamber (step 1404). In some embodiments, the seasoning ingredient includes both solids and liquids as in the instance where the seasoning mixture is formed from seasoning particles mixed with oil or a liquid containing oil. The seasoning ingredients may also be formed from only solids or only liquids. For example, an unseasoned food piece arriving at the seasoning system 1200 or 1300 may have been previously removed from a fryer and covered by a thin coat of oil. Additional oil may not be necessary or desirable; thus, the seasoning applied to the food piece may include only solid seasoning particles.

The seasoning ingredients are mixed in the mixing vortex to form a seasoning mixture (Step 1406). After the seasoning ingredients are mixed, the seasoning mixture is expelled from the mixing chamber to coat a food piece (step 1408). As previously mentioned, the seasoning mixture may be sprayed onto the food pieces as they are conveyed beneath the mixing nozzle on an endless conveyor, or the food pieces may be sprayed with the seasoning mixture as they are agitated in a tumbler in a batch process.

Although embodiments of the invention have been described with reference to several elements, any element described in the embodiments described herein are exemplary and substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### ADDITIONAL DESCRIPTION

The following clauses are offered as further description of the novel aspects of the disclosed invention:

In a first aspect, the disclosure describes a mixing nozzle comprising: a housing defining a mixing chamber, wherein the mixing chamber comprises a sidewall separating a first end from a second end; a set of tangential feed conduits extending outwardly from the mixing chamber and through the housing, wherein the set of tangential feed conduits are oriented tangentially to mixing chamber; and an outlet orifice in the second end of the mixing chamber, wherein the outlet orifice is one end of an exit channel extending through the housing.

Another embodiment including any one or more of the elements in a previous embodiment disclosed above, wherein the mixing nozzle further comprises: an axial inlet orifice located in the first end of the mixing chamber.

Another embodiment including any one or more of the elements in a previous embodiment disclosed above, wherein the inlet orifice is aligned with the outlet orifice.

Another embodiment including any one or more of the elements in a previous embodiment disclosed above, wherein the sidewall of the mixing chamber is curved, and wherein the mixing chamber is at least partially cylindrical.

Another embodiment including any one or more of the elements in a previous embodiment disclosed above, wherein the first end of the mixing chamber and the curved sidewall define a cylinder, and wherein the second end of the mixing chamber has a shape that is one of a hemisphere or a cone.

Another embodiment including any one or more of the elements in a previous embodiment disclosed above, wherein the mixing nozzle further comprises a primary auger; and an auger coupling attached to a first exterior end of the housing, wherein the auger coupling is in fluid communication with the axial inlet port, and wherein the auger coupling further comprises a trunk sized to receive at least a distal end of the primary auger.

Another embodiment including any one or more of the elements in a previous embodiment disclosed above, wherein the mixing nozzle further comprises: a secondary auger; and wherein the auger coupling further comprises a branch extending from the trunk, and wherein the branch is sized to receive at least a distal end of the secondary auger.

Another embodiment including any one or more of the elements in a previous embodiment disclosed above, wherein the auger coupling further comprises a liquid inlet port extending outwardly from the trunk.

Another embodiment including any one or more of the elements in a previous embodiment disclosed above, wherein the mixing nozzle further comprises: a removable nozzle insert maintained within the housing and downstream from the mixing chamber, wherein the removable nozzle insert is selected to alter flow characteristics of a seasoning mixture expelled from the mixing nozzle.

Another embodiment including any one or more of the elements in a previous embodiment disclosed above, wherein the mixing nozzle further comprises: a set of high shear inlet ports extending outwardly from the housing, wherein at least one of the set of high shear inlet ports connects a feed line with a high shear feed conduit that passes through the housing and into the exit channel.

In a second aspect, the disclosure describes a system for seasoning food pieces, the system comprising: a mixing nozzle comprising a housing defining a mixing chamber with a sidewall separating a first end from a second end, wherein the mixing nozzle further comprises a set of tangential feed conduits extending outwardly from the mixing chamber and through the housing, and wherein the mixing chamber comprises an outlet orifice in the second end, wherein the outlet orifice is one end of an exit channel extending through the housing; and a set of storage vessels in fluid connection with the mixing nozzle, wherein the set of storage vessels stores phase-separated ingredients mixed in the mixing nozzle.

Another embodiment including any one or more of the elements in a previous embodiment disclosed above, wherein the system further comprises: a compressor coupled to at least the mixing nozzle by a first feed line, wherein the compressor provides a pressurized gas to the mixing nozzle.

Another embodiment including any one or more of the elements in a previous embodiment disclosed above, wherein the first feed line is connected at least to a tangential inlet port.

Another embodiment including any one or more of the elements in a previous embodiment disclosed above, wherein the set of storage vessels further comprises a seasoning tank and an oil reservoir.

Another embodiment including any one or more of the elements in a previous embodiment disclosed above, wherein at least one of the seasoning tank and the oil reservoir is pressurized with gas from a compressor.

Another embodiment including any one or more of the elements in a previous embodiment disclosed above, wherein the seasoning tank is coupled to the mixing nozzle by a second feed line, and wherein the second feed line is connected to at least one of a tangential inlet port, an axial inlet port, a high shear inlet port, and an auger coupling attached to a first exterior end of the housing.

Another embodiment including any one or more of the elements in a previous embodiment disclosed above, wherein the second feed line is connected to the auger coupling, and wherein the second feed line partially houses either a primary auger or a secondary auger.

Another embodiment including any one or more of the elements in a previous embodiment disclosed above, wherein the oil reservoir is coupled to the mixing nozzle by a third feed line, wherein the third feed line is connected to at least one of a tangential inlet port, a high shear inlet port, or an auger coupling.

Another embodiment including any one or more of the elements in a previous embodiment disclosed above, wherein the set of storage vessels further comprises an oil reservoir in fluid communication with the mixing nozzle via a third feed line, wherein the third feed line extends from the oil reservoir to the first feed line connecting the compressor and the mixing nozzle.

Another embodiment including any one or more of the elements in a previous embodiment disclosed above, wherein the mixing nozzle further comprises a nozzle insert selected to alter flow characteristics of a seasoning mixture expelled from the mixing nozzle, wherein the nozzle insert is maintained within the housing and downstream from the mixing chamber.

1. A mixing nozzle for applying seasoning to food pieces, the mixing nozzle comprising:
a housing defining a mixing chamber, wherein the mixing chamber comprises a sidewall separating a first end from a second end;
a set of tangential feed conduits extending outwardly from the mixing chamber and through the housing, wherein the set of tangential feed conduits are oriented tangentially to mixing chamber; and
an outlet orifice in the second end of the mixing chamber, wherein the outlet orifice is one end of an exit channel extending through the housing, and
wherein phase-separated seasoning ingredients received by the mixing nozzle are mixed in the mixing chamber and expelled from the exit channel to season the food pieces.

2. The mixing nozzle of claim 1, further comprising:
an axial inlet orifice located in the first end of the mixing chamber.

3. The mixing nozzle of claim 2, wherein the inlet orifice is aligned with the outlet orifice.

4. The mixing nozzle of claim 1, wherein the sidewall of the mixing chamber is curved, and wherein the mixing chamber is at least partially cylindrical.

5. The mixing nozzle of claim 4, wherein the first end of the mixing chamber and the curved sidewall define a cylinder, and wherein the second end of the mixing chamber has a shape that is one of a hemisphere or a cone.

6. The mixing nozzle of claim 2, further comprising:
a primary auger; and
an auger coupling attached to a first exterior end of the housing, wherein the auger coupling is in fluid communication with the axial inlet port, and wherein the auger coupling further comprises a trunk sized to receive at least a distal end of the primary auger.

7. The mixing nozzle of claim 6, further comprising:
a secondary auger; and
wherein the auger coupling further comprises a branch extending from the trunk, and wherein the branch is sized to receive at least a distal end of the secondary auger.

8. The mixing nozzle of claim 6, wherein the auger coupling further comprises a liquid inlet port extending outwardly from the trunk.

9. The mixing nozzle of claim 1, further comprising:
a removable nozzle insert maintained within the housing, wherein the removable nozzle insert is selected to alter flow characteristics of a seasoning mixture expelled from the mixing nozzle.

10. The mixing nozzle of claim 1, further comprising:
a set of high shear inlet ports extending outwardly from the housing, wherein at least one of the set of high shear inlet ports connects a feed line with a high shear feed conduit that passes through the housing and into the exit channel.

11. A system for seasoning food pieces, the system comprising:
a mixing nozzle comprising a housing defining a mixing chamber with a sidewall separating a first end from a second end, wherein the mixing nozzle further comprises a set of tangential feed conduits extending outwardly from the mixing chamber and through the housing, and wherein the mixing chamber comprises an outlet orifice in the second end, wherein the outlet orifice is one end of an exit channel extending through the housing; and
a set of storage vessels in fluid connection with the mixing nozzle, wherein the set of storage vessels stores phase-separated ingredients mixed in the mixing nozzle, and
wherein phase-separated seasoning ingredients received by the mixing nozzle are mixed in the mixing chamber and expelled from the exit channel to season the food pieces.

12. The system of claim 11, further comprising:
a compressor coupled to at least the mixing nozzle by a first feed line, wherein the compressor provides a pressurized gas to the mixing nozzle.

13. The system of claim 12, wherein the first feed line is connected at least to a tangential inlet port.

14. The system of claim 11, wherein the set of storage vessels further comprises a seasoning tank and an oil reservoir.

15. The system of claim 14, wherein at least one of the seasoning tank and the oil reservoir is pressurized with gas from a compressor.

16. The system of claim 14, wherein the seasoning tank is coupled to the mixing nozzle by a second feed line, and wherein the second feed line is connected to at least one of a tangential inlet port, an axial inlet port, a high shear inlet port, and an auger coupling attached to a first exterior end of the housing.

17. The system of claim 16, wherein the second feed line is connected to the auger coupling, and wherein the second feed line partially houses either a primary auger or a secondary auger.

18. The system of claim 14, wherein the oil reservoir is coupled to the mixing nozzle by a third feed line, wherein the third feed line is connected to at least one of a tangential inlet port, a high shear inlet port, or an auger coupling.

19. The system of claim 12, wherein the set of storage vessels further comprises an oil reservoir in fluid communication with the mixing nozzle via a third feed line, wherein the third feed line extends from the oil reservoir to the first feed line connecting the compressor and the mixing nozzle.

20. The system of claim 11, wherein the mixing nozzle further comprises a nozzle insert selected to alter flow characteristics of a seasoning mixture expelled from the mixing nozzle, wherein the nozzle insert is maintained within the housing and downstream from the mixing chamber.
